(19) United States
(12) Patent Application Publication
(10) Pub. No.: US 2007/0294337 A1
(43) Pub. Date: Dec. 20, 2007

(54) CLIENT-SIDE INFORMATION PROCESSING SYSTEM, APPARATUS AND METHODS

(76) Inventors: Maria Gaos, Bothell, WA (US); Nazih Youssef, Bothell, WA (US)

Correspondence Address: AXIOS LAW GROUP. PLLC, 1525 FOURTH AVENUE, SUITE 800, SEATTLE, WA, 98101, US

(21) Appl. No.: 11/773,524

(22) Filed: Jul. 5, 2007

Related U.S. Application Data
(63) Continuation-in-part of application No. 11/693,666, filed on Mar. 29, 2007.
(60) Provisional application No. 60/744,052, filed on Mar. 31, 2006.

(51) Int. Cl. G06F 15/16

(52) U.S. Cl. 709/203

(57) ABSTRACT

System, apparatus and methods of information processing comprising receiving a request to execute an application on a configurable platform, receiving parameters corresponding to an emulation architecture for execution of the application, generating the emulation architecture according to the parameters for execution on the configurable platform, reconfiguring the configurable platform for execution of the application on the emulation architecture, and executing the application on the emulation architecture on a reconfigured configurable platform that is operative to execute the emulation architecture.

### CROSS-REFERENCE TO RELATED APPLICATIONS

This application is a continuation-in-part of U.S. patent application Ser. No. 11/693,666 entitled “CLIENT-SIDE INFORMATION PROCESSING SYSTEM AND METHODS,” filed Mar. 29, 2007, which is based upon and claims the benefit of priority from Provisional Application No. 60/744,052 filed Mar. 31, 2006. The entire contents of both applications are incorporated herein by reference.

### FIELD

The present disclosure relates generally to information processing, and in particular but not exclusively, relates to a system, apparatus and methods for custom configuration of electronic user devices.

### BACKGROUND

Communications between electronic devices have improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Current products and systems for the production, delivery and manipulation of multi-media and communications are:

Too Specialized:

For example, x86 processor style computers (“PCs”), Macintoshes (“Macs”), Console game devices and the like generally share similar hardware and a display devices. However, each has its own special purpose. The PC is recognized for its processing power, multi-tasking, and the wide range of applications that are only available for the PC. On the other hand, Macs are thought of as superior than the PC from a graphic artist's point of view; they are better and faster in rendering and graphic visualization. Likewise, game devices are often specialized not only for games but only for its specific type of games. Another example is the remote control, often there a special remote for every device in the household. Users often get tired of having so many remotes around the house. They may buy a multi-device remote, but then find that the multi-device remote is too complicated and simply end up with one more remote and more clutter.

Fragmented:

For example, if a user prepares a document on the Mac using Word Perfect, then they cannot use it on the PC (and vice versa) unless they have the right conversion software. Similarly, there are the differences between graphics signals on Macs and PCs. Likewise there may be further differences, including: I/O formats, files extensions, and the like. What is applicable for one system is not applicable to the other. In another example, the user may have a computer but cannot watch TV on the computer monitor because the computer has no TV tuner. The user is presented with the dilemma of whether to buy a TV tuner to enable his device or not, and often the decision has been to ignore the upgrade opportunity and avoid the hassle.

Bundled:

For example: when a user buys Microsoft Office, they might need Word or Excel, but end up paying for more applications that they never needed or wanted such as Access, Front page, Publisher because they are bundled with Word and Excel, thereby providing a non-value added product to buyer at their own expenses.

Redundant:

For example, having a DVD player and remote for each of the following devices in most of households: stand alone TV, home theatre, PC, Mac, Game device, etc.

Require High Demand on the Literacy Level to Operate:

For example, the PC has been around for over 25 years and using the PC might sound like a trivial task for people who have a good literacy level and who overcame the fear of using the PC. However, many people still do not know how to use their PC even if they own one. It is common to still see ads to teach people the elementary steps on how to use the PC or the Mac. Similarly, since all devices do not operate in the same way, the amount of Instruction's Manuals and the need to become their bookkeepers is a hassle for users.

Short Life Cycle and High Replacement Rate:

For example, each game device (X-Box, Game Cube, Play Station, etc. . . . ) has its own special I/O format, therefore the user has to buy different game devices for different games, and within short period games software producers develop a new game with different specs, thus forcing the user to buy new game device, etc.

Difficult to Use and to Maintain:

For example, many users have to buy a new computer almost every 3-5 years because the new applications require more capabilities than their current computers which cause financial burdens users and more stress on the environment.

This situation has resulted in an extensive waste of resources and the generation of hazardous waste, e.g., monitors, disc drives, circuit boards, etc.

Another problem is the generation of information barriers between those in the know and the rest of the population which exacerbates the so-called “digital divide.”

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a communications network including multiple processing nodes and communications with multiple geographic locations in an embodiment.

FIG. 2A is a block diagram illustrating a representative set of devices coupled to a platform in an embodiment.

FIG. 2B is a block diagram illustrating a representative set of user devices coupled to a communications network in an embodiment.

FIG. 3 is a block diagram illustrating a platform in an embodiment.

FIG. 4A is a flow diagram illustrating the flow of operation of the platform in an embodiment.

FIG. 4B is a flow diagram outlining the flow of operation of the platform in an embodiment.

FIG. 4C is a flow diagram outlining the flow of operation of the platform in an embodiment.

FIG. 4D is a flow diagram outlining the flow of operation of the platform in an embodiment.

FIG. 5 is a flow diagram outlining the flow of operation of the platform in an embodiment.

FIG. 6 is a flow diagram outlining the flow of operation of the platform in an embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined without limiting the scope to the embodiments disclosed herein.

Some example embodiments that address one or more of the problems identified above include embodiments that offer an adaptable long life cycle platform with the capabilities of executing multiple applications simultaneously and is easy to use without the demand for a high literacy level while incorporating the recognition of limited income factors.

That platform can be reconfigurable in multiple ways to replace the “dedicated for use” ones and thus accommodating various applications without the need for new “dedicated products.” Using such a platform may reduce current product disposal rates and levels by means of shifting the paradigm of having to produce “dedicated hardware” to sell software.

Additionally it may be possible to increase the software product development efforts (instead of the short-lived hardware) that provide the true “value added” for the user as well as the manufacturers. Including enhancing “product sharing” abilities worldwide.

Some embodiments may also be capable of standardizing delivery structures and adapting to the upcoming ones by design. This delivery adaptability may be accomplished by providing:

(1) User Reconfigurable interactive platform—Multiple user platform interfaces such as a personal assistant (avatar), and cognitive communication with the user through speech processing and artificial intelligence, keyboard, remote control, etc.
(2) Remote host for operations, controls and interface services, etc.—Remote hosts for storing authentication, various multi-media applications, platforms emulation software, firewalls, user's non-private profiles, e.g. region of residence, selected applications and its frequency etc., general applications, e.g., e-banking, e-medical, e-shopping, e-entertainment, etc.
(3) Artificial Intelligence engine at the remote hosts for processing gathered data to assist delivering most relevant services to the users.
(4) Intelligent center including Artificial Intelligence engine coupled with the operation and control center, remote hosts, and communicates with user's platform.
(5) Networks between and among the above components, e.g., networks between the remote hosts and the users of the platform for providing the users with various multi-media applications, platform emulation software and additional storage and processing capabilities, etc.

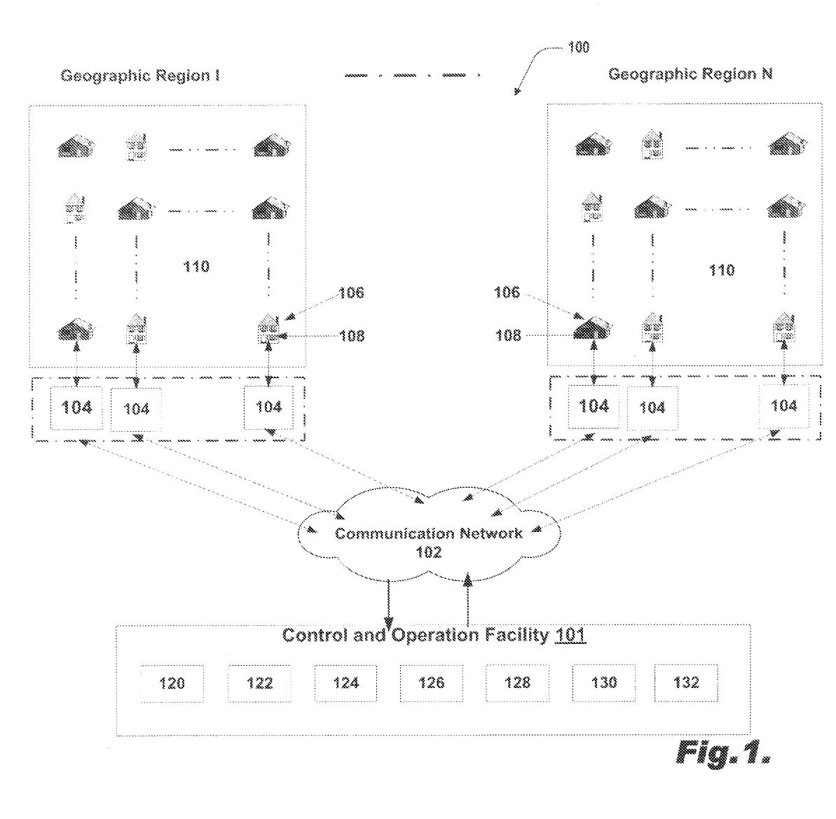

One exemplary embodiment of such a processing system 100 is illustrated in FIG. 1. The processing system 100 includes several components, a control and operations facility 101, a communication network 102, a plurality of intermediate processing nodes 104, and a plurality of geographic regions 110. Each region includes a plurality of households and different properties. Each household 106 includes a user device 108 that is coupled to a plurality of electronic devices used by an end user or consumer. The communication network 102 provides a choice of communication media including a private network, high bandwidth networks (cable network, DSL, T1 and the like), public switched telephone network (“PSTN”), satellite network or Internet, etc. Each geographic region 110 covers a distinct geographic area and includes a plurality of households and the information processing requirements of each household are provided through the plurality of intermediate processing nodes 104 and enabled by communication through communication network 102 to and from the control and operations facility 101. The control and operations facility 101 includes multiple components with multiple functions, an example of these components are: a remote host server 120 that provides for the computing and information processing requirements of each user device 108 provided in each household, an Artificial Intelligence engine 122 for storing and processing end user-platform interactions and for assisting in data analysis, information retrievals, information extractions, etc., and an Intelligence center services host 124 for assisting the user through cognitive interaction dialogs with avatars and/or interactions with real personal assistants through audio, video, email or any other forms of human interactions, expansion host server 126 that provides the end user temporarily with additional processing power and/or extra storage capabilities which can be temporary or for longer periods depending on user needs. Search engine component 128 coupled with the Artificial Intelligence engine, data and information system 130 for storing users' non private profiles and relevant information, and application remote hosts 132 for providing the users with multimedia software applications, emulation and simulation software, speech processing applications, email, etc. The aforementioned components communicate with each other as well as with other components. The communication network 102 provides communication between intermediate processing nodes 104 and the central and operation faculty 101. The plurality of intermediate processing nodes 104 are provided so that each intermediate node is assigned a geographic region 110 to which information messages are passed back and forth between the control communications facility 101 and the plurality of user devices 108 provided in each household 106. The plurality of intermediate nodes may be assigned to handle the information processing requirements for each geographic region and the control and operations facility 101 will insure adequate load balancing and redistribution of processing capabilities between and among intermediate processing nodes to support the processing required in each distinct geographic region 110.

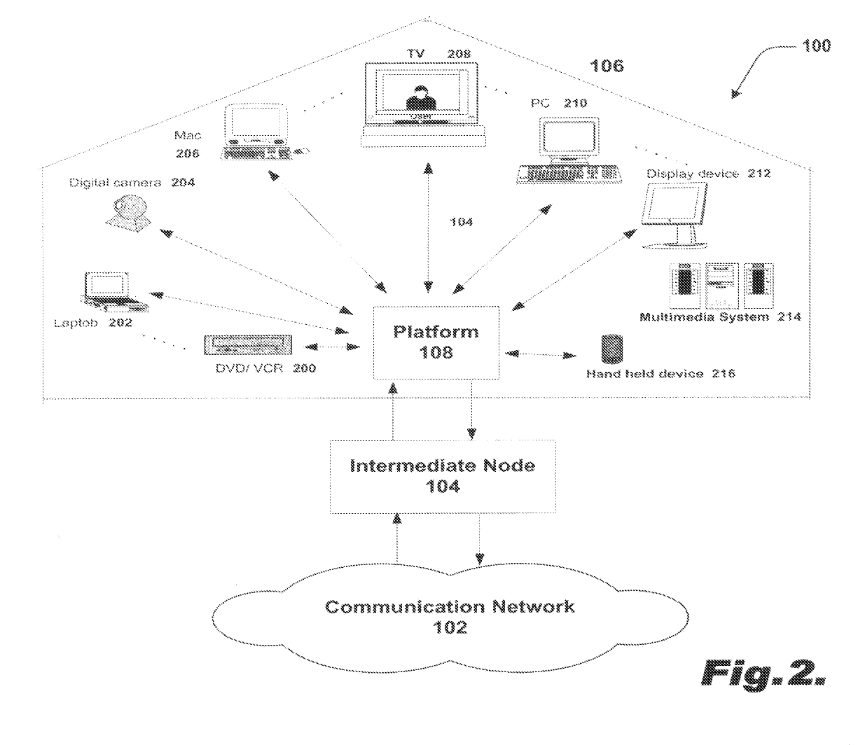

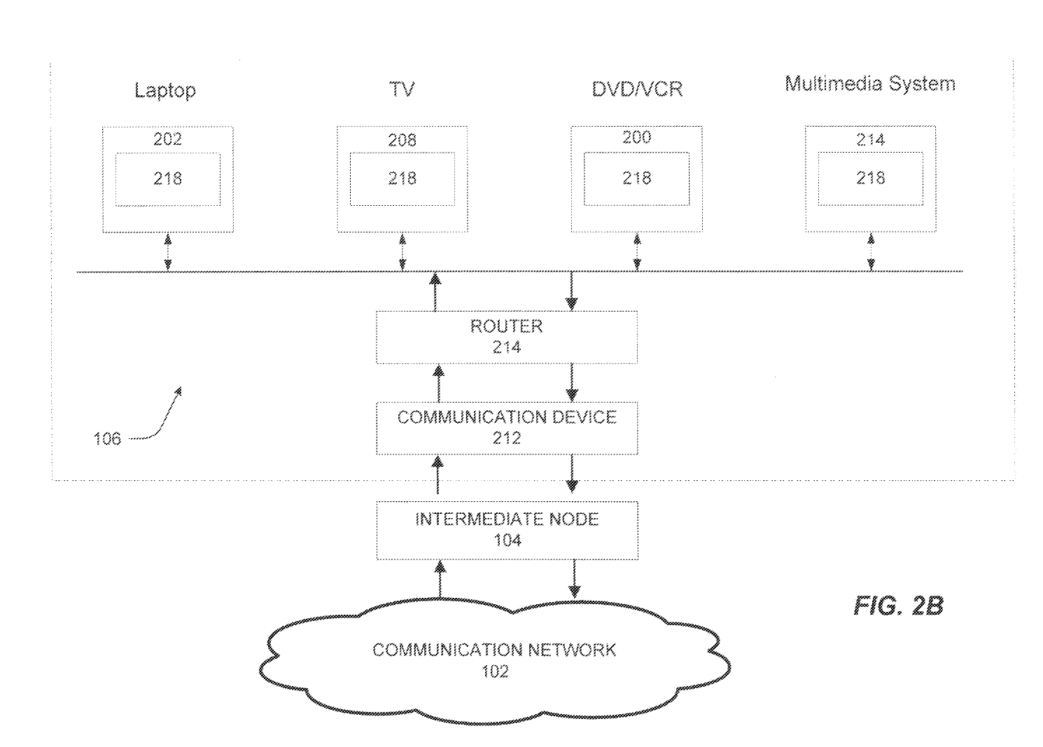

FIG. 2 provides a more detailed view of a portion of an embodiment of processing system 100 that includes a communication network 102 that communicates through intermediate node 104 to an illustrative embodiment of a household 106. Household 106 includes a platform in an exemplary embodiment. Platform 108 communicates with a plurality of household electronic and consumer devices. Among the internal household devices to which the platform 108 may communicate are DVDs and VCR controllers 200, laptop computer 202, digital cameras 204, Mac computer 206, TVs or televisions 208, desk top computer 210, display devices 212, multimedia systems 214, and a plurality of handheld computing devices 216 (e.g., blackberry, blueberry handheld computers).

FIG. 2B provides yet another exemplary embodiment of the information processing system. In this Figure, communication network 102 and then communicates with intermediate node 104 to a household 106 through a communication device 212 which is coupled to router 214 which is in turn coupled to a household local area network 216. Each of the plurality of household consumer devices are coupled to local area network 216 to facilitate information transfer and necessary processing of user request and control center commands to the user device 218. As shown in this Figure, electronic device 202 (laptop computer) includes an embedded module that is an embodiment of the user device 218. Likewise, television 208 includes an embedded user device 218 along with embedded user devices 218 included in the other illustrative embodiments of electronic devices such as DVD, VCR recorder 200 and multimedia system 214. In this configuration of the information processing system there is no centralized user device 108 but rather a plurality of embedded modules including the capabilities of user device 108 which modules have been embedded in each of a plurality of electronic devices available for use by a household end user. This is a representative example of a decentralized embodiment and thereby facilitates custom configuration of each electronic user device and each embedded user device to the specific needs of the end user.

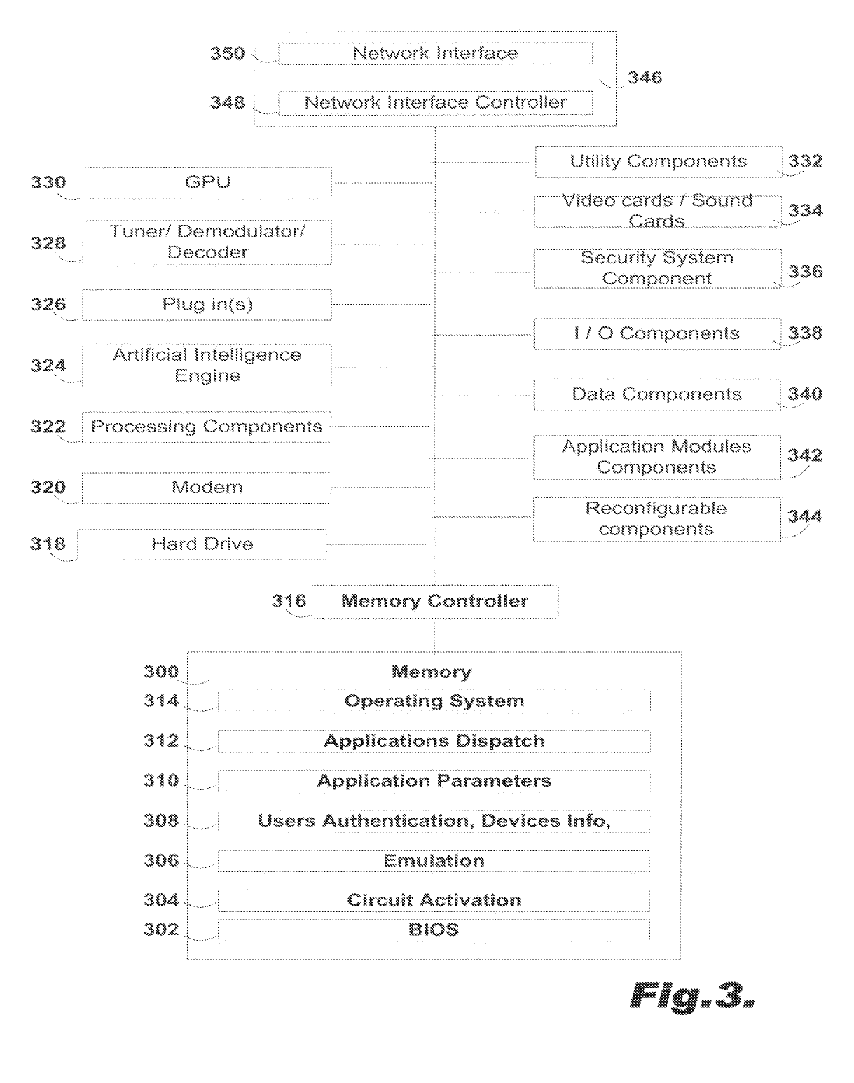

FIG. 3 includes a block diagram of an exemplary embodiment of the user platform 108, having hardware components: a memory 300, a BIOS 302, circuit activation 304, emulation component 306, users authentication and devices info 308, application parameters 310, application dispatch component 312, operating system 314, memory controller 316, hard drive 318, plurality of modems 320, processing components 322, a resident Artificial Intelligence engine 324, a plurality of plug-in docs 326, a tuners component 328 which contain a cable-ready and NTSC analog tuner, and digital tuner/demodulator/MPEG decoder circuit to receive analog and DTV on the platform and on an analog/digital display device, and for recording DTV broadcast on the hard drive, AaGraphics Processing Unit or GPU for graphic rendering 330, utility component 332, video Card/sound card 334, Security system component 336, Input/output component 338, a data component 340, applications modules component 342, a reconfigurable component 344, and a network interface component 346. Network interface component 346 includes a network interface controller 348 coupled to a network interface 350. Each of the components is coupled together in the computing architecture as shown in FIG. 3. A brief description of each component's function is presented below: Memory 300 stores various components such as:

BIOS 302 is stored on the flash memory on the motherboard and its main function is to load the proper operating system and to manage the interfaces of the major hardware components, e.g., the hard drive 318 with the operating system 314. Circuit activation program 304 is executed by processing components 322 to configure hardware circuits in a desired configuration using the reconfigurable component 344 to enable the execution of desired platform emulation or a desired selected application. The platform emulation 306 stored in memory 300 represents previously executed platform emulations and parameters required by the processing components 322 to execute a previously stored and executed platform emulation 306.

Authentication program 308 authenticates household users, the device and the location of the device and the user based on additional information gathered by input-output component 338.

The application parameters 310 stored in memory 300 are comprised of application specific parameters and emulation parameters. Application parameters are received by input-output component 338 and stored in memory 300 after a user makes a selection for a particular application.

Application dispatch program 312 is executed by processing components 322 if the selected application is not stored in the user device 108 on hard drive 318. Application dispatch program 312 upon execution issues a request to a remote host server and control and operations facility 101 to retrieve the application from a plurality of stored applications on the remote host server, the retrieved application is thereafter stored in hard drive 318. The application dispatch program 312 is also used to issue requests to the remote host server and central and operations facility 101 to generate application specific emulations or platform emulations that are to be used and executed on the user device 108 to support the execution of the selected application made by the end use of an electronic devices such as a laptop computer 202, a television set 208 or multimedia system 214. Application dispatch program 312 will issue a request to have the remote host server and control and operations facility 101 generate a new platform emulation when the processing components 322 determines based on the selected application that the required hardware platform or platform emulation is not stored in hard drive 318 or in memory 300. The request to have a platform emulation generated includes a set of application parameters and an emulation specific request; both the parameters and the emulation specific request are provided to the remote host server for the generation of desired platform emulation. After generation of the platform emulation, the remote host server downloads the platform emulation to the user device 108 and it is thereafter stored on hard drive 318. The remote host server downloads both the platform emulation and the emulation parameters required for execution of the platform emulation in a manner that supports execution of the selected application made by an end user of an electronic device.

Operating system 314 and memory 300 may be any of a number of conventional operating systems or embedded real time operating systems for execution in the user device 108 with processing components 322.

Memory controller 316 is coupled to hard drive 318 and memory 300 and processes requests from the processing components 322 for access to applications or to access parameters or programs stored in memory 300.

Another exemplary embodiment of the user platform includes hard drive 318 which stores applications that were used previously by end users of the electronic devices.

Plurality of modems components 320 provides Internet data connectivity at different rates such as 56K DSL, ISDN, Cable, etc.

Processing components 322 provide the essential processing capability of the user device and are used to process requests based on application selections made by end users of electronic devices for execution of specific applications or the retrieval and execution of specific platform emulations to enable the execution of selected applications by users of the electronic devices. The processing components 322 will determine which electronic device the application will be displayed on based on the specific needs and characteristics of the target electronic device as determined by information provided by input output component 338.

Resident Artificial Intelligence engine 324 for analyzing and facilitating user-platform interactions, collecting and sorting data.

The plurality of plug-in docs 326 is provided to received plug-in cartridges having application stored thereon for execution on specific electronic devices

Tuners component 328 which contain a cable-ready and NTSC analog tuner, and digital tuner/demodulator/MPEG decoder circuit to receive analog and DTV on the platform and on a analog/digital display device, and for recording DTV broadcast on the hard drive,

A Graphics Processing Unit or GPU 330 for graphic rendering,

Utility component 332, includes different functions such as problem diagnosis, dispatch request, and encryption and /decryption, etc., A router/processor for executing and sustaining in a “multi-task” mode multiple applications on capable devices is available in the household [i.e. assign desired configurations to operate simultaneously other household devices at different locations], and to facilitate the modular configurations to account for an expandable storage and processing capabilities when needed.

Video card/Sound card 334, assisting in the interaction with multimedia applications, Cognitive communication with the users through audio and video technology including speech recognition, animation and graphical illustrations.

Security system component 336, to provide enhanced security and authentication by including multidirectional microphones and cameras coupled with sensors fusion engine.

Input/output component 338 is coupled to each of the plurality of electronic devices included in the household to enable the user device 108 to communicate with each device to determine and monitor each user's application selection on each of these devices.

The data component 340 includes a storage capability to record each selection made by a user of an application to be executed on an electronic device and includes additional storage capabilities to record the frequency with which such applications are selected. Applications modules component 342, including multimedia applications, emulation modules for emulating on demand various platforms thus reducing the demand on additional devices, etc.

Reconfigurable component 344 includes a hardware component to enable the reconfiguration of embedded hardware circuitry to enable the execution of supplemental or advanced computing capabilities to enhance the use of the selected application desired by a user of an electronic device. In an embodiment, the reconfigurable component 344 is implemented as a field-programmable gate array (FPGA). In alternative embodiments, the reconfigurable component 344 is implemented as an electrically erasable and programmable read-only memory (EEPROM), a partially-reconfigurable field programmable gate array (PRFPGA), or an electrically programmable read-only memory (EPROM). Alternately, or in addition to hardware configurations, reconfigurable components 344 (or one or more other components within the user device 108) may also support one or more operating systems. The reconfigurable components 344 can also be optimized for energy consumption efficiency and speed depending on the processing requirements of requested emulation architectures and desired applications. In addition, reconfigurable components 344 enable features and attributes of the emulation architectures and user applications to be enable or disabled upon request.

Network interface component 346 includes a network interface controller 348 coupled to a network interface 350.

Network interface controller 348 controls which type of interface the user device is coupled to for communication to and from the control and operations facility 101 and in the embodiment shown in FIG. 2 the communication to and from each embedded electronic device.

Network interface 350, each of its components is coupled in the computing architecture as shown in FIG. 3.

Operation:

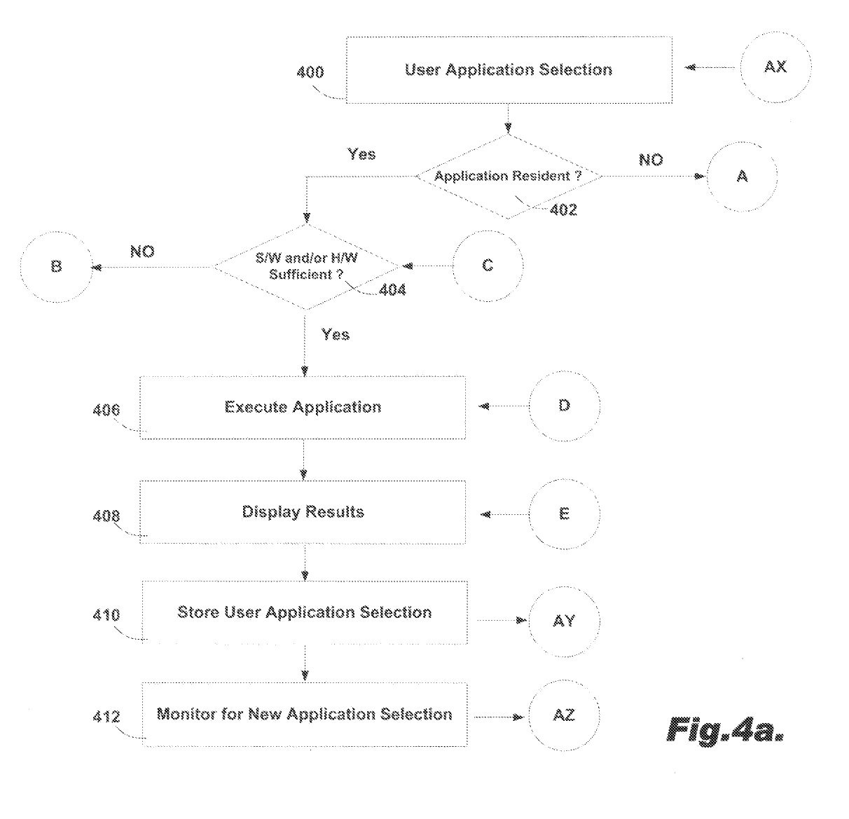

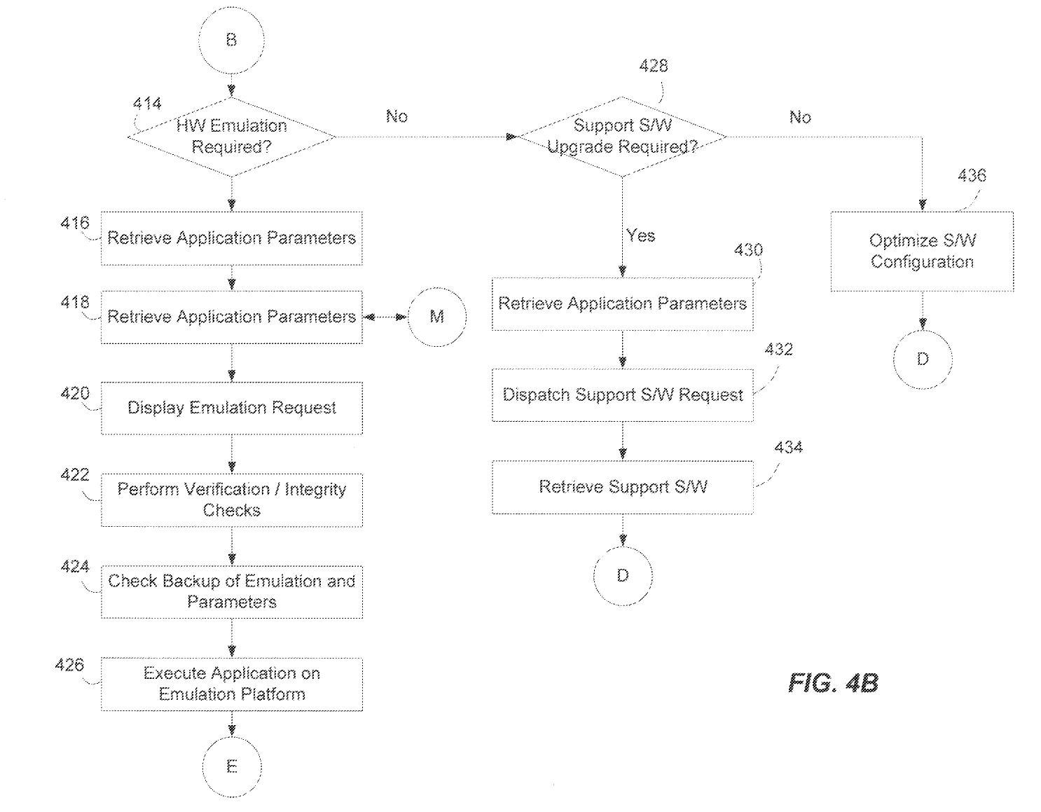

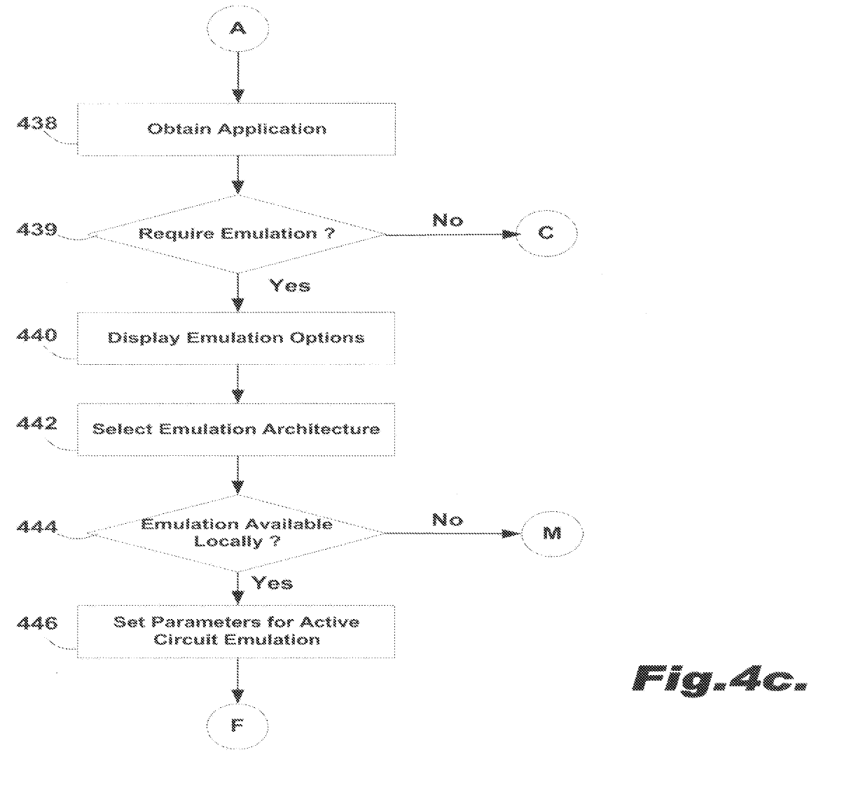

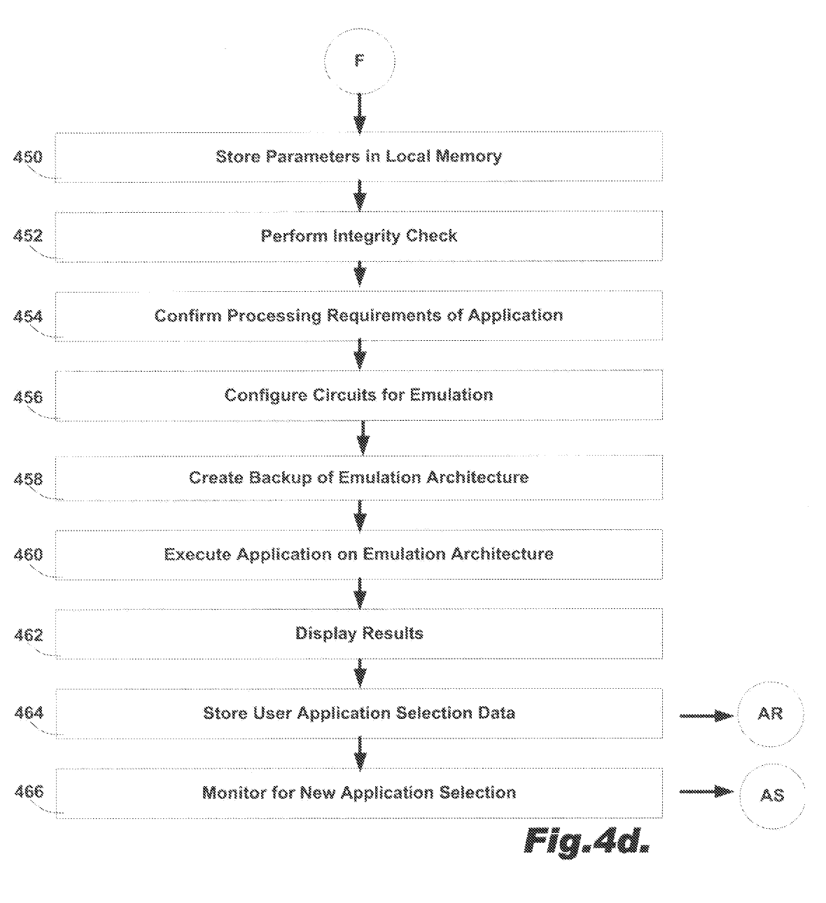

FIG. 4A is a flow diagram outlining the general flow of operation of the user device upon receiving a user application selection. In the embodiment shown in this figure, a user specifies a selection request for an application; however, in alternative embodiments the application selection can be received from the control and operation control facility 101, and the platform itself if the application that has been selected is incompatible with or otherwise unable to be executed on the platform. In the latter case, the request received from the platform in the event the application is incompatible with the configuration of hardware circuits and soft circuits, will cause a reconfiguration of the hardware circuits, soft circuits or both to enable execution of the application on the platform. As shown in FIG. 4A, user application selection request 400 initiates an internal process to determine whether the selected application is resident as shown at step 402. If the application selected is resident on the user device 108 or in the alternative embodiment of an embedded module shown in FIG. 2B (module 218), then the user device 108 will determine whether the existing hardware and software platform is sufficient to execute the desired application as shown at step 404. If the existing hardware and software architecture are sufficient to execute the application, then the user device 108 will execute the application as shown at step 406. The results of the execution of the application will be displayed on the desired electronic device as shown at step 408. The selection made by the user of the particular application will be identified added in the data component 340 in step 410 (and a remote device may also be updated as shown in step 550) and the user device 108 will enter into a wait state and continue to monitor for a new user application selection as shown at step 412 (see also step 512). In the event the application is not resident as determined by the analysis of step 402 then the user device 108 will proceed to obtain the required application as shown at step 438 (in FIG. 4C).

In obtaining the desired application, the user device 108 may retrieve the application from hard drive 318 or activate the application dispatch program 312 and have it issue a request which will include application parameters 310 to have the remote host server in control and operations facility 101 find the application which will subsequently be downloaded by the remote host server to the user device 108. As shown in FIG. 4C, obtaining the application at step 438 initiates an internal process to determine whether the downloaded application requires emulation as shown in step 439. If the application does not require emulation, then the device proceeds to determine if existing SW/HW are capable 404, if capable it then proceeds to 406, if not capable then it proceeds to 428. In the event the application requires emulation, then the user device 108 will display emulation options on the electronic device for additional input from an end user as shown at step 440. Input information is provided by the end user to select a specific or target emulation architecture as shown at step 442 and then the user device will then determine whether the emulation is available locally in its local memory as shown at decision step 444. If the emulation is not available locally then a request will be made to retrieve application parameters as shown at step 416 and eventually execute the application on emulation platform at 426 followed by displaying results at 408. The selection made by the user of the particular application will be identified and added in the data component 340 in step 410 and the user device 108 will enter into a wait state and continue to monitor for a new user application selection as shown at step 412.

In the event the emulation is available locally the platform emulation will be retrieved from memory and the emulation parameters required for its execution will be set to an active circuit emulation as shown at step 446.

In FIG. 4D, after the emulation parameters are received from the generation of a platform emulation by the remote host server, those parameters are stored in the local memory as shown at step 450. The processing components 322 will then perform an integrity check as shown at step 452 to ensure that the platform emulation functions as specified for the required hardware architecture needed by the selected application. The processing components 322 will also confirm the processing requirements of the application as shown at step 454 and then proceed to configure all circuits both hardware circuits and soft circuits for execution of the platform emulation as shown at step 456. In an alternative embodiment, the platform circuits are configured based on one or more requirements specified in a reconfiguration request received from either the user or the control and operation facility 101 before any reconfiguration of the circuits based on the processing requirements of a selected application. The reconfiguration request can include specific configuration parameters for the hardware circuits as well as the soft circuits used for execution of emulation architectures. In yet a different embodiment, the reconfiguration of the circuits in the platform for an emulation architecture is performed according to requirements established by the user or control and operation facility 101 without an explicit reconfiguration request. In this instance, the requirements can be established in advance or on a preset basis.

The processing components 322 will continue their execution and create a backup or replication copy of the platform emulation as shown at step 458 and then proceed with the execution of the selected application on the platform emulation as shown at step 460. Afterwards the results from the executed application will be displayed as shown at step 462 on the electronic device of choice by the end user and the selection made by the user of the particular application will be stored in the data component 340. The data component 340 includes a data store for storing the frequency with which particular user applications are selected and the types of applications that are selected so that the control and operations facility will be able to determine the number of times particular applications are selected by end users in specific geographic regions and thereby shift or moderate information processing capabilities across its network of intermediate processing nodes and make available specific applications for specific geographic regions after learning or compiling additional data that enables the control and operations facility to learn the types of application usage patterns that are common to end users in specific geographic regions. After storing application selection data in step 464 the processing components 322 and the user device will then move into a wait state and continue monitoring for a new application selection as shown at step 466.

Returning to FIG. 4A, in the event the application is resident but is incompatible with or cannot be executed on the existing hardware and software architecture as shown at step 404 then the process shown in flow diagram of FIG. 4B will be executed.

If in decision step 414, it is determined that hardware emulation is required, the processing components 322 will retrieve the application parameters from the input-output component 338 and store them in memory 300 as shown at step 416. Afterwards the processing components 322 will execute the application dispatch program to issue a request as shown at step 418 to have a new platform emulation generated by remote host server in control and operations facility 101. The platform emulation will be retrieved and downloaded from the control and operations facility 101 and stored on hard drive 318 in the user device along with emulation parameters to enable processing components 322 to successfully execute the platform emulation as shown at step 420. After download of the platform emulation and its corresponding parameters, processing components 322 will perform a verification and a series of integrity checks on the platform emulation as shown at step 422. Next, processing components 322 will create a backup of the platform emulation and its corresponding emulation parameters as shown at step 424 and then execute the application on the platform emulation as shown at step 426. Processing will then cycle back to step 408.

Returning to step 414, where the user device determines whether hardware emulation is required, if hardware emulation is not required then the processing components 322 will determine whether additional support software will be required or whether an upgrade to the supporting software will be required to properly execute the selected application as shown at step 428.

If an upgrade of the support software is required, the processing components 322 will retrieve the application parameters as shown in 430 and execute application dispatch program 312 to have a request sent to the remote host server and control an operation facility 101 as shown at step 432 to have support software generated by the remote host server which will subsequently be retrieved and downloaded as shown at step 434 to the user device. The processing components 322 in user device 108 will cycle back to step 406.

In the event a support software upgrade is not required, as determined in step 428, the user device 108 will proceed to optimize the default software configuration for operation with the selected application, as shown in step 436 and cycle back to step 406.

FIG. 4C includes a flow diagram of the application dispatch process executed by application dispatch program 312. After executing the appropriate “soft circuits” included in the platform emulation, the emulation parameters will be stored in local memory 300 as shown in FIG. 4D.

The process shown in FIG. 4D will be executed to complete the storage of the emulation parameters in local memory 300 as shown at step 450, to perform relevant integrity checks as shown at step 452 and to confirm the processing requirements of the desired application as shown at step 454. The circuit configuration for the optimized platform emulation will be stored as shown at step 458 and the selected application program will be executed on the platform architecture as shown at step 460 and the results of the execution of this application will be displayed on the desired electronic device used by the end user as shown at step 462. The user profile stored in the data component will be updated with additional information on the selected application program to correlate data on both the application selected and the frequency of selection made by the end user of a particular device in a particular household 106 is provided by step 464 (and a remote device may also be updated as shown in step 550). The user device will then return to a wait state and monitor for a new application selection as shown at step 466 (see also step 512).

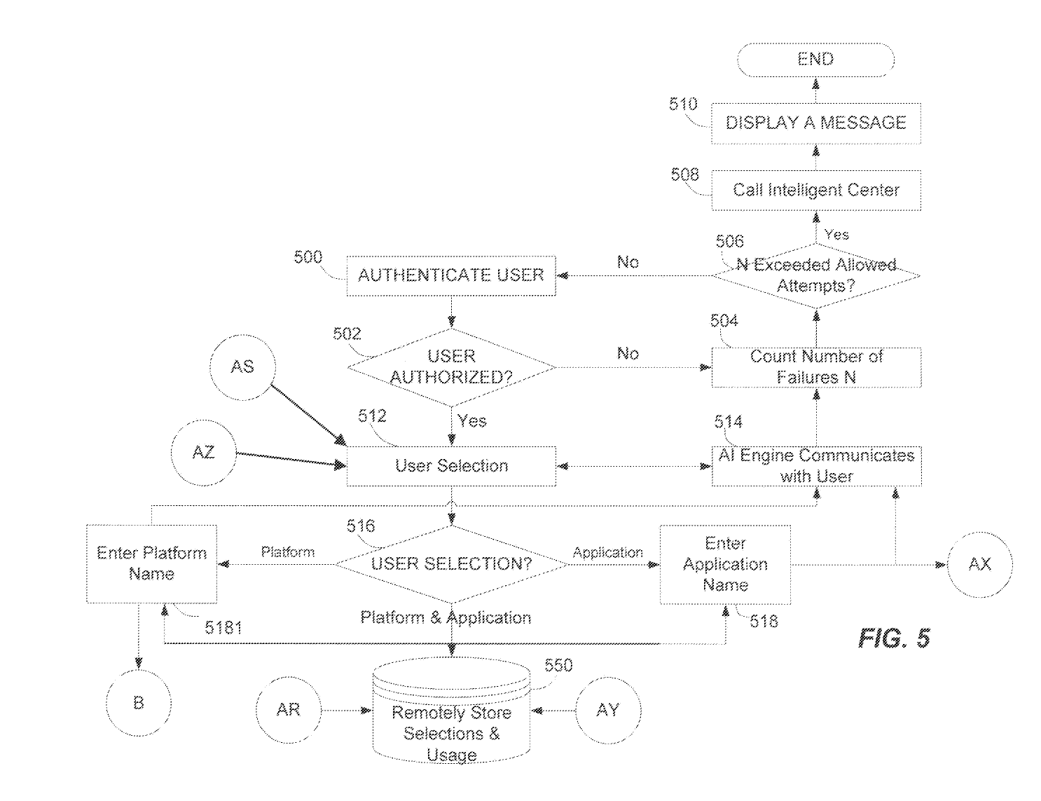

FIG. 5 is a flow diagram outlining the general flow of operation of the user device 108 upon turning on its power. The processor of user authentication module 308 coupled with system security component 336 initiates with the user a cognitive dialog as shown at step 500 which includes different interaction format, e.g. through a display device, audio, video, photo, thump print, etc. To authorize the user at step 502, the user is given allocated a specific number of trials at 504 to get authorization; if exceeded, then processor 506 connects the user to the intelligence center 508 to provide the user with the diagnosis and recommendations as shown at 510.

If the user authorization is approved then the processing components 322 coupled with the artificial intelligence engine of the device 324 shown at step 514 interact with the user prompting him to enter his selection as shown at step 512. The completion of the selection process at 512 initiates an internal processor included among the processing components 322 at step 516 to determine whether the selection is an application, or a platform, or both as shown in FIG. 5. The internal processor is then prompts the user to enter the name of the selected application at step 518 (selected platform at step 5181) or names of both at steps 518 and 5181, which is then followed by activating various processes as outlined in FIGS. 4a-4d.

Speech Processing:

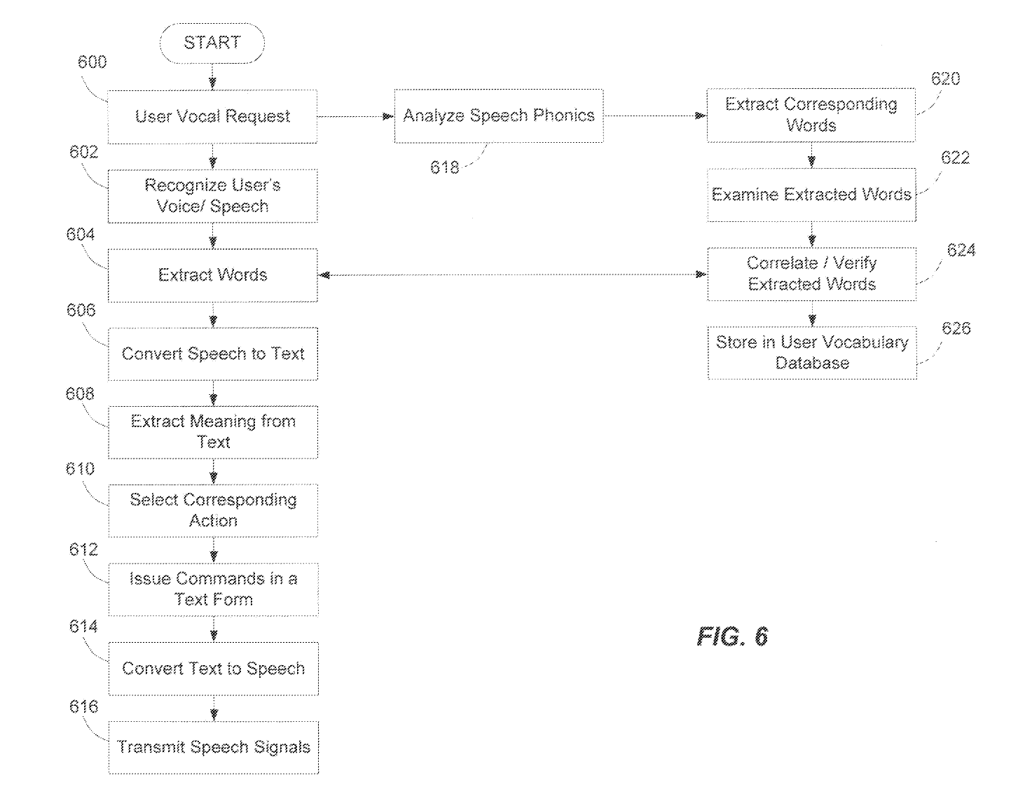

User interaction with the platform includes many types of forms and many types of devices, e.g. mouse, keyboard, microphone, and universal remote control. Each type of devices is colored coded with its own LCD display and with reciprocity and instant helper shown on the display device pursuing users who cannot read to be able to use the platform. When using microphones or equivalents then user sound/speech/voice-platform interaction is in the form of an interactive cognitive dialog and is driven by sound/speech/voice recognition system and an artificial intelligence engine. Flow diagram for its operation is shown in FIG. 6. User request is entered at step 600 and is analyzed in terms of voice/sound recognition and speech recognizer processors included among the processing components 322 at step 602, this is followed by word extraction at 604 by using vocabulary and grammar model that is stored on application modules components 342. In the meantime user sound/speech is analyzed by a speech phonic processor 322 at 618 which is followed by word extraction at 620 which is examined for its meaning and its consistency by the internal processors 322 and the artificial intelligence engine 324 as shown in 622. This is followed by correlation and verification of extracted words at step 624 with the extracted words at 604, which in turn is stored in user vocabulary database 340 at step 626, which is used in phonic analysis for next user interaction sessions at step 618. Extracted words at 604 are converted text form at 606, which is used for meaning extraction at 608 by using semantic rules module stored at components 342. This meaning is then analyzed by the internal processors 322, artificial intelligence engine 324 at step 610 and accordingly a corresponding action is selected from the vocabulary and grammar model that is stored at the application model 342 and the speech data bank stored in the data component 340, and is issued in text form at 612, which is then converted to speech at 614 with the aid of a text to speech synthesizer module stored at the application components 342. This speech is then transmitted to the user through a speaker, earphone, etc.

Platform Universal Remote Control

Platform universal remote control has multiple recognition and interaction capabilities in a consolidated and/or dedicated fashion, a limited example of which are remote mouse, phone, microphone, speaker, pointer devices, sound/speech/voice device, and all other capabilities such as operating the TV, DVD, etc. Each type of devices may be colored coded with its own LCD display and with reciprocity and instant helper shown on the display device pursuing users who cannot read to be able to use the platform. It is also capable of self charging or operating on batteries,

Platform Architecture

The platform is an applications transport platform analogous to a seaport/airport with the capabilities of receiving, shipping/landing and takeoff of multiple sorts of multi-media applications, while managing itself without subjecting the users to the frustration and the hassles of hardware/software limitations and updates.

The disclosed architecture is designed to handle all types of traffic and loads through the use of currently available technology and technologies likely be developed in the future such as dual and multiple core circuits and is presently intended in doing so by introducing the use of stackable (shelves) locations to enhance the board circuitry capabilities and to manage the required activity level.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. A method of information processing, the method comprising:
receiving a selection request to execute an application on a configurable platform;
receiving parameters corresponding to an emulation architecture for execution of the application;
generating the emulation architecture according to the parameters for execution on the configurable platform;
reconfiguring the configurable platform for execution of the application on the emulation architecture; and
executing the application on the emulation architecture, the reconfigured configurable platform operative to execute the emulation architecture.

2. The method of claim 1 wherein the received request is generated from a user.

3. The method of claim 1 wherein the received request is generated from a control center.

4. The method of claim 1 wherein the received request is generated from the configurable platform if execution of the application is incompatible with the configurable platform.

5. The method of claim 4 wherein the reconfiguring of the configurable platform renders execution of the application compatible with the reconfigured configurable platform.

6. The method of claim 1 further comprising receiving a reconfiguration request from a user to reconfigure the configurable platform before the reconfiguring of the configurable platform.

7. The method of claim 6 wherein the reconfiguring of the configurable platform is based on one or more requirements specified in the reconfiguration request received from the user.

8. The method of claim 1 further comprising receiving a reconfiguration request from a control center to reconfigure the configurable platform before the reconfiguring of the configurable platform.

9. The method of claim 8 wherein the reconfiguring of the configurable platform is based on one or more requirements specified in the reconfiguration request received from the control center.

10. The method of claim 1 wherein the reconfiguring of the configurable platform is based on a plurality of processing requirements of the requested application.

11. The method of claim 1 wherein the reconfiguring of the configurable platform is performed according to user specified requirements.

12. The method of claim 1 wherein the reconfiguring of the configurable platform is performed according to control center specified requirements.

13. A method of information processing, the method comprising:
receiving a selection request to execute an application on a configurable platform;
receiving parameters corresponding to an emulation architecture for execution of the application;
generating the emulation architecture according to the parameters for execution on the configurable platform; and
executing the application on the emulation architecture, the configurable platform operative to execute the emulation architecture.

14. The method of claim 13 wherein the received request is generated from a user.

15. The method of claim 13 wherein the received request is generated from a control center.

16. The method of claim 13 wherein the received request is generated from the configurable platform if execution of the application is incompatible with the configurable platform.

17. The method of claim 16 wherein the emulation architecture generated according to the parameters renders execution of the application compatible with the configurable platform.

18. A method of information processing, the method comprising:
receiving a selection request to execute an application on a configurable platform;
reconfiguring the configurable platform for execution of the application; and
executing the application on the reconfigured configurable platform.

19. The method of claim 18 wherein the received request is generated from a user.

20. The method of claim 18 wherein the received request is generated from a control center.

21. The method of claim 18 wherein the received request is generated from the configurable platform if execution of the application is incompatible with the configurable platform.

22. The method of claim 21 wherein the reconfiguring of the configurable platform renders execution of the application compatible with the reconfigured configurable platform.

23. The method of claim 18 further comprising receiving a reconfiguration request from a user to reconfigure the configurable platform before the reconfiguring of the configurable platform.

24. The method of claim 18 further comprising receiving a reconfiguration request from a control center to reconfigure the configurable platform before the reconfiguring of the configurable platform.

25. The method of claim 18 wherein the reconfiguring of the configurable platform is based on a plurality of processing requirements for executing the requested application.

26. The method of claim 18 wherein the reconfiguring of the configurable platform is performed according user specified requirements.

27. The method of claim 18 wherein the reconfiguring of the configurable platform is performed according to control center specified requirements.

28. A configurable information processing apparatus, the apparatus comprising:
a memory;
a processor coupled to the memory; and
at least one configurable component coupled to the processor, the processor operative to:
receive a selection request to execute an application using the at least one configurable component;
receive parameters corresponding to an emulation architecture for execution of the application;
generate the emulation architecture according to the parameters for execution on the at least one configurable component;
reconfigure the at least one configurable component for execution of the application on the emulation architecture; and
execute the application on the emulation architecture, the reconfigured at least one configurable component operative to execute the emulation architecture.

29. The apparatus of claim 28 wherein the at least one configurable component is a field-programmable-gate-array (FPGA).

30. The apparatus of claim 28 wherein the at least one configurable component is an electrically erasable and programmable read-only memory (EEPROM).

31. The apparatus of claim 28 wherein the at least one configurable component is a partially-reconfigurable field programmable gate array (PRFPGA).

32. The apparatus of claim 28 wherein the at least one configurable component is an electrically programmable read-only memory (EPROM).

33. The apparatus of claim 28 wherein the request is generated from a user.

34. The apparatus of claim 28 wherein the request is generated from a control center.

35. The apparatus of claim 28 wherein the request is generated from the at least one configurable component if execution of the application is incompatible with the at least one configurable component.

36. The apparatus of claim 35 wherein the reconfiguring of the at least one configurable component renders execution of the application compatible with the reconfigured at least one configurable component.

37. The apparatus of claim 28 wherein the processor is further operative to receive a request from a user to reconfigure the at least one configurable component before the processor is operative to reconfigure the at least one configurable component.

38. The apparatus of claim 37 wherein the processor is operative to reconfigure the at least one configurable component based on one or more requirements specified in the request received from the user.

39. The apparatus of claim 28 wherein the processor is further operative to receive a request from a control center to reconfigure the at least one configurable component before the processor is operative to reconfigure the at least one configurable component.

40. The apparatus of claim 39 wherein the processor is further operative to reconfigure the at least one configurable component based on one or more requirements specified in the request received from the control center.

41. The apparatus of claim 28 wherein the processor is operative to reconfigure the at least one configurable component based on a plurality of processing requirements of the requested application.

42. The apparatus of claim 28 wherein a user request renders the processor operative to reconfigure the at least one configurable component.

43. The apparatus of claim 28 wherein a control center request renders the processor operative to reconfigure the at least one configurable component.

44. A configurable information processing apparatus, the apparatus comprising:
a memory;
a processor coupled to the memory; and
at least one configurable component coupled to the processor, the processor operative to:
receive a selection request to execute an application using the at least one configurable component;
receive parameters corresponding to an emulation architecture for execution of the application;
generate the emulation architecture according to the parameters for execution on the at least one configurable component; and
execute the application on the emulation architecture, the at least one configurable component operative to execute the emulation architecture.

45. The apparatus of claim 44 wherein the received request is generated from a user.

46. The apparatus of claim 44 wherein the received request is generated from a control center.

47. The apparatus of claim 44 wherein the received request is generated if execution of the application is incompatible with the at least one configurable component.

48. The apparatus of claim 47 wherein the emulation architecture generated according to the parameters renders execution of the application compatible with the at least one configurable component.

49. The apparatus of claim 44 wherein the at least one configurable component is a field-programmable-gate-array (FPGA).

50. The apparatus of claim 44 wherein the at least one configurable component is an electrically erasable and programmable read-only memory (EEPROM).

51. The apparatus of claim 44 wherein the at least one configurable component is a partially-reconfigurable field programmable gate array (PRFPGA).

52. The apparatus of claim 44 wherein the at least one configurable component is an electrically programmable read-only memory (EPROM).

53. A configurable information processing apparatus, the apparatus comprising:
a memory;
a processor coupled to the memory; and
at least one configurable component coupled to the processor, the processor operative to:
receive a selection request to execute an application using the at least one configurable component;
reconfigure the at least one configurable component for execution of the application; and
executing the application on the reconfigured at least one configurable component.

54. The apparatus of claim 53 wherein the received request is generated from a user.

55. The apparatus of claim 53 wherein the received request is generated from a control center.

56. The apparatus of claim 53 wherein the received request is generated if execution of the application is incompatible with the at least one configurable component.

57. The apparatus of claim 56 wherein the reconfiguring of the at least one configurable component renders execution of the application compatible with the reconfigured at least one configurable component.

58. The apparatus of claim 53 wherein the processor is further operative to receive a reconfiguration request from a user to reconfigure the at least one configurable component before the processor is operative to reconfigure the at least one configurable component.

59. The apparatus of claim 53 wherein the processor is further operative to receive a reconfiguration request from a control center to reconfigure the at least one configurable component.

60. The apparatus of claim 53 wherein the processor is operative to reconfigure the at least one configurable component based on a plurality of processing requirements for executing the requested application.

61. The apparatus of claim 53 wherein the processor is operative to reconfigure the at least one configurable component from one or more requirements specified in a user request.

62. The apparatus of claim 53 wherein the processor is operative to reconfigure the at least one configurable component from one or more requirements specified in a control center request.

63. The apparatus of claim 53 wherein the at least one configurable component is a field-programmable-gate-array (FPGA).

50. The apparatus of claim 53 wherein the at least one configurable component is an electrically erasable and programmable read-only memory (EEPROM).

51. The apparatus of claim 53 wherein the at least one configurable component is a partially-reconfigurable field programmable gate array (PRFPGA).

52. The apparatus of claim 53 wherein the at least one configurable component is an electrically programmable read-only memory (EPROM).

63. A computer-readable medium having instructions stored thereon for performing the method of claim 1.

64. A computer-readable medium having instructions stored thereon for performing the method of claim 13.

65. A computer-readable medium having instructions stored thereon for performing the method of claim 18.
